(19) United States
(12) Patent Application Publication
(10) Pub. No.: US 2012/0164615 A1
(43) Pub. Date: Jun. 28, 2012

(54) TRAINING SYSTEM FOR APPLYING A MEDICAL COMPRESSION PRODUCT, AND A DEVICE AND PROGRAM FOR USE THEREWITH

(75) Inventor: Jawad Ameen Jawad Al Khaburi, PC Ruwi 112 (OM)

(73) Assignee: CONVATEC TECHNOLOGIES INC., Las Vegas, NV (US)

(21) Appl. No.: 13/048,279

(22) Filed: Mar. 15, 2011

Related U.S. Application Data
(60) Provisional application No. 61/426,121, filed on Dec. 22, 2010.

(51) Int. Cl. G09B 23/28

(52) U.S. Cl. 434/267

(57) ABSTRACT

A system for training a practitioner to apply a medical compression product (“MCP”) may include an artificial limb having a geometry representative of a limb of a patient and a plurality of sensors disposed on the artificial limb. The artificial limb may be adapted for the practitioner to apply an MCP (e.g., a bandage) thereto, and the training system may be configured to provide feedback information to the practitioner regarding the application of the MCP. The feedback information may include quantitative information, such as: numerical values representing the pressure applied by the MCP to the limb at various locations; target pressure values; and numerical differences between the target and applied pressure values. The feedback information may also include qualitative information, such as: color coded pressure maps, and text and/or audio signals.

### CROSS-REFERENCE TO RELATED APPLICATIONS

This application claims the benefit of the filing date of U.S. Provisional Patent Application No. 61/426,121 filed Dec. 22, 2010, the disclosure of which is hereby incorporated herein by reference.

### BACKGROUND OF THE INVENTION

1. Field of the Invention

The present invention relates to a system for training a practitioner to apply a medical compression product, such as a bandage, and also to an artificial limb and a program for use with such a training system.

2. Description of the Related Art

External compression applied using one of a variety of medical devices, collectively known as medical compression products (“MCP”), is the cornerstone of treatment for patients with venous disease and/or lymphoedema. MCP may include: extensible or non-extensible bandages (used with or without other interface materials); hosiery applied in one or more layers; orthostatic products (e.g., non-extensible sheets applied using a hook-and-loop fastening system); and pneumatic devices. The successful use of MCP may depend upon application of the products in a way that ensures that effective pressures (i.e., “interface pressures”) are applied between the product and the patient's skin.

One technique to assist in gauging whether the correct pressure has been applied by a bandage is through the use of geometric shapes on the bandage (e.g., ellipses or rectangles sewn or printed on the surface) that expand as the bandage is stretched during application. The geometric shapes are designed such that they distort to form a different shape (e.g., a circle or square, respectively) when a predetermined pressure or amount of extension has been applied. However, it can be difficult to determine at what point a geometric shape on the surface of the bandage has reached the target shape.

Another technique for indicating when the correct pressure is being applied includes providing two lines on the surface of a bandage that are spaced apart by a known distance. As the bandage is applied, the lines move apart due to the stretching of the material. The desired pressure may be indicated by a particular distance between the lines, which can be confirmed, for example, by comparison to spaced-apart marks on a reference card.

Alternatively, bandage manufacturers may simply recommend that the product be extended by a certain proportion (e.g., 50%) of its unstretched length. However, in practice, it can be difficult to estimate the required extension as a proportion of the unstretched length. Moreover, it can be difficult to maintain the desired amount of extension during the course of applying the entire bandage to the patient.

### BRIEF SUMMARY OF THE INVENTION

Compression bandages are typically applied by trained practitioners. It would be desirable for such practitioners, as part of their training, to learn how to apply bandages in a consistent and accurate manner. Unfortunately, the above-discussed techniques for determining the interface pressure applied by a compression bandage can be inaccurate and difficult to use. Therefore, further improvement in this area would be desirable.

One aspect of the present invention provides a system for training a nurse or practitioner to apply a medical compression product. A system according to this aspect of the invention may include an artificial limb, a processor, and an output device. The artificial limb may have a geometry representative of a limb of a patient. The artificial limb may include a plurality of sensors, and each of the sensors may be operable to measure a predetermined parameter indicative of a pressure being applied by the medical compression product to the artificial limb. The sensors may be arranged on the limb to provide measurements with respect to at least first and second locations on the limb.

The processor of the system according to the above aspect of the invention may be arranged to receive data from the sensors corresponding to the predetermined parameter measured by the sensors. The processor may be operable to compare the data received from the sensors to a plurality of numerical target pressure ranges. The numerical target pressure ranges may include a first target pressure range relating to the first location on the limb. The numerical target pressure ranges may also include a second target pressure range relating to the second location on the limb. The second target pressure range may have a different range of values than the first target pressure range.

The output device of the system according to the above aspect of the invention may be connectable to the processor. The output device may be adapted to provide a non-numerical indication to an operator with respect to the first location when the pressure applied by the medical compression product to the artificial limb at the first location is within the first target pressure range. The output device may be adapted to provide the same non-numerical indication with respect to the second location as with respect to the first location when the pressure applied by the medical compression product to the artificial limb at the second location is within the second target pressure range.

According to one aspect of the invention, the artificial limb has a geometry representative of a leg of a patient. According to another aspect of the invention, the sensors of the artificial limb may be arranged in a plurality of groups, with each group being associated with a different region of the artificial limb.

According to a further aspect of the invention, the output device may be a visual display. According to another aspect of the invention, the non-numerical indication may be a text-based signal. According to yet another aspect of the invention, the non-numerical indication may be a color-coded signal. In accordance with this aspect of the invention, the color-coded signal may be provided on a graphical representation of the artificial limb.

Still another aspect of the invention provides a non-transitory computer readable medium having stored thereon a program executable by a computer.

### BRIEF DESCRIPTION OF THE DRAWINGS

FIG. 1 is a side view of an artificial leg, depicting cross-sectional profiles at various levels.

FIG. 2 is a chart indicating the location of pressure sensors on an artificial leg, such as that illustrated in FIG. 1.

FIG. 3A is a perspective view of a training system in accordance with one embodiment of the invention.

FIG. 3B is a schematic view of the training system of FIG. 3A.

FIG. 4 is a flow chart for a program run by a processor of the training system of FIGS. 3A-B.

FIGS. 5A-B are exemplary displays of an output device of the system of FIGS. 3A-B.

### DETAILED DESCRIPTION

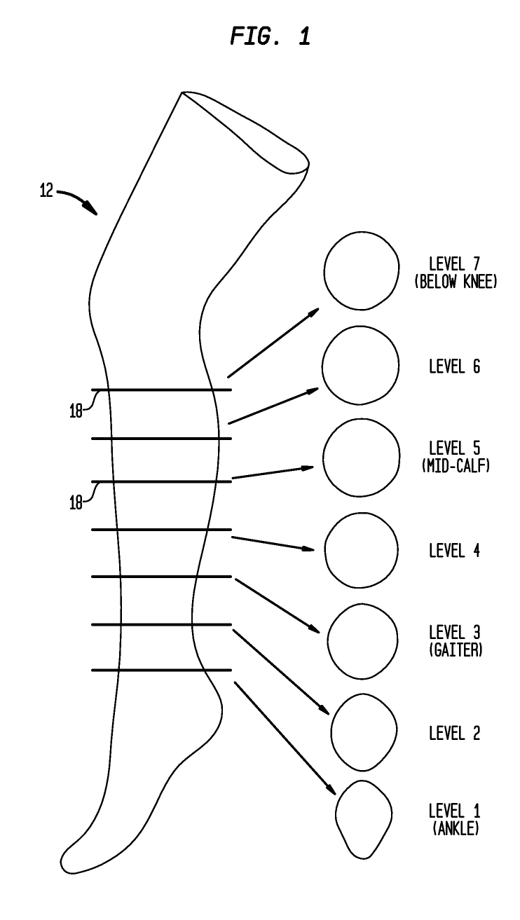

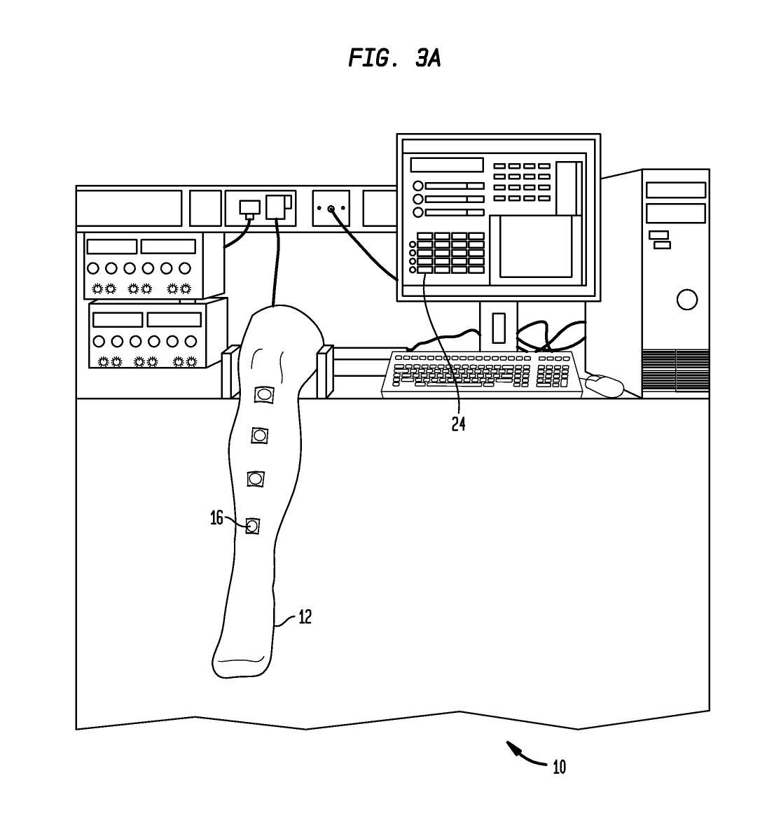

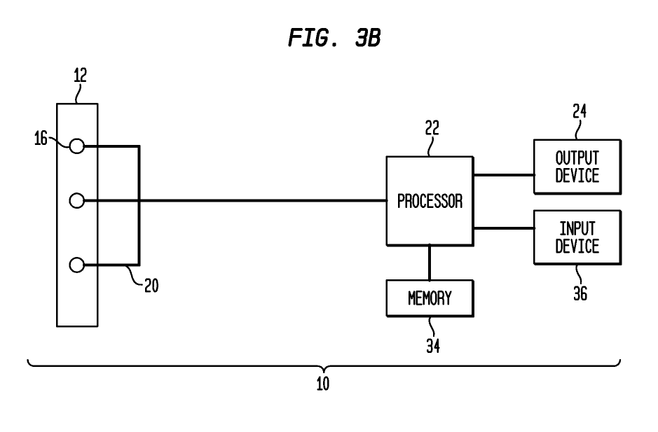

As shown in FIGS. 3A-B, a system 10 for training a nurse or practitioner to apply MCP (e.g., compression bandages) in accordance with one embodiment of the invention may include an artificial limb 12 and a computer system 14. The artificial limb 12 may have a geometry representative of a limb of a patient. For example, FIG. 1 depicts the artificial limb 12 having a geometry representative of a human leg. The limb 12 may be arranged so that a user can practice applying MCP to the limb 12 (e.g., wrapping elongated compression bandages around the limb 12). Embodiments of the training system 10 may include multiple artificial limbs of different types (e.g., arms, legs, etc.) and/or limbs having different morphologies (e.g., mimicking morphologies caused by certain conditions treated by MCPs), so that the user can practice applying MCPs in those different scenarios.

The artificial limb 12 used in the training system 10 may include a plurality of force and/or pressure sensors 16 disposed therealong. The sensors 16 are configured and arranged to measure the normal force and/or normal pressure applied to the surface of the limb 12. Preferred types of sensors may include (but are not limited to): piezoelectric sensors; resistive or piezoresistive sensors (see, e.g., FLEXIFORCE® sensors manufactured by Tekscan, Inc. of Boston, Mass.; TACTILUS® sensors manufactured by Sensor Products Inc. of Madison, N.J.; FSR® sensors manufactured by Interlink Electronics, Inc. of Camarillo, Calif.; and model FS01 sensors manufactured by Honeywell International Inc. of Morristown, N.J.); sensors utilizing quantum tunneling composites (“QTCs”); capacitive sensors (see, e.g., sensors manufactured by Pressure Profile Systems, Inc. of Los Angeles, Calif.; sensors manufactured by Novel GmbH of Munich, Germany; and sensors manufactured by Xsensor Technology Corporation of Calgary, Canada); pneumatic-based pressure transducers (see, e.g., the PICOPRESS™ system manufactured by Microlab Elettronica of Ponte San Nicolo, Italy); and fluid-based pressure transducers.

The exposed surface of each sensor 16 may project slightly or may be substantially flush with the outer surface of the limb 12. For example, the exposed surface of each sensor 16 may project less than about 1 mm above the outer surface of the limb 12, and may even project less than about 0.5 mm above the outer surface. In this regard, portions of the sensors 16 may be at least partially embedded within the surface of the limb 12.

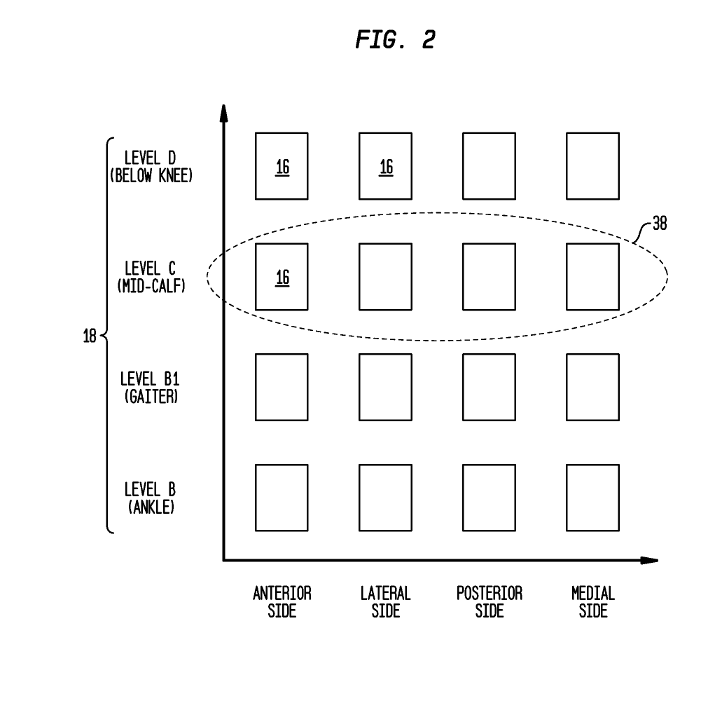

The sensors 16 are desirably arranged at different locations along the limb 12, so as to provide an indication of the applied force and/or pressure at those different locations. In one embodiment, in which the artificial limb 12 has the geometry of a leg, as illustrated in FIG. 1, sixteen sensors 16 may be provided. As illustrated in FIG. 2, the sensors 16 may be arranged at four different levels 18 (e.g., ankle, gaiter, mid-calf, and below-knee) along the artificial leg. Four of the sensors 16 may be disposed around the artificial leg at each of those levels 18 (e.g., on the anterior, lateral, posterior, and medial sides of the leg). In other embodiments, more or fewer levels may be provided, with more or fewer sensors located at each level.

Each sensor 16 may be connected to wires 20 that connect the sensors 16 to the computer system 14. The wires 20 may run through the interior of the limb 12. The wires may be adapted to transmit signals between the sensors 16 and the computer system 14. As an alternative (not shown), the signals may be transmitted wirelessly between the sensors and the computer system using a variety of technologies, such as Bluetooth, radio-frequency identification (“RFID”), ZigBee, etc. The computer system 14 may include a processor 22 configured to process the signals from the sensors 16 and communicate information to the user through an output device 24, such as a visual display (e.g., a LCD computer monitor) and/or an audio device (e.g., a speaker). FIGS. 3A and 3B illustrate the training system 10 in accordance with one embodiment of the invention, including an artificial limb 12 and associated computer system having an output device 24.

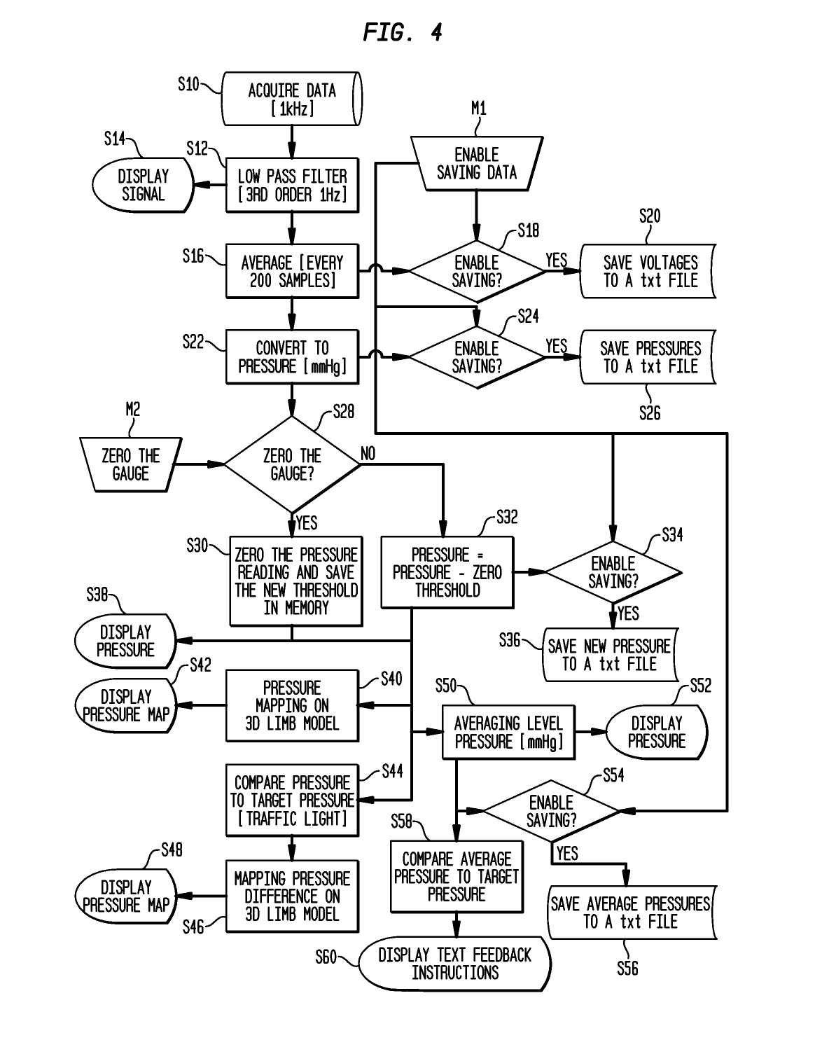

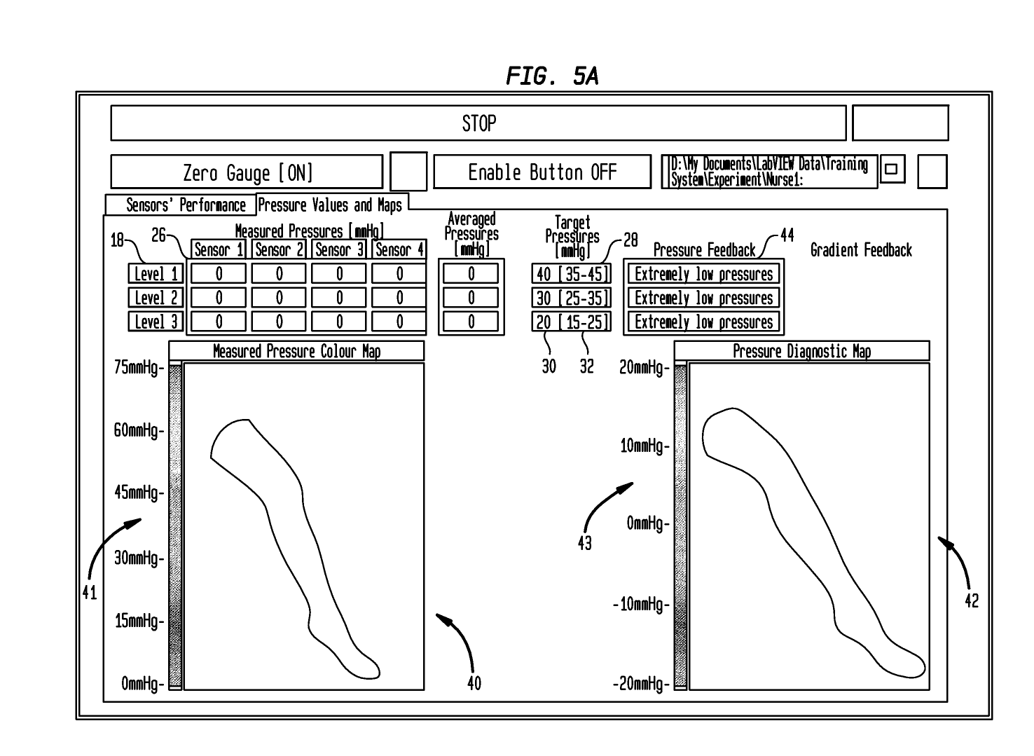

FIG. 4 illustrates an exemplary flow chart for a program which may be run by the processor 22 for acquiring data from the sensors 16 and displaying information via the output device 24. Such program may be supplied to the computer system 14 from an external source for immediate use thereat or for storage and subsequent use thereat, or, alternatively, may be stored in a non-transitory computer readable medium for use with the computer system 14. Such medium may include a computer disc, a hard disc drive, a read-only memory (“ROM”), a random-access memory (“RAM”), or other types of computer readable storage devices. As an example, such program may be stored in memory 24 of computer system 14. Additionally, it is noted that, although the steps of the program illustrated in the flow chart are shown in a particular order, a program in accordance with an embodiment of the invention may perform the steps in any desired order.

In step S10, data is acquired from the sensors 16 at a predetermined sampling frequency. That predetermined sampling frequency may be, for example, 1 kHz. The data may be in the form of voltages from the sensors 16. In step S12, the signal comprising the acquired data is passed through a filter, such as a low pass filter, which may remove noise from the signal. One exemplary low pass filter may be a third-order filter with a cutoff frequency of 1 Hz. The filtered signal is displayed by the output device 24 in step S14.

In step S16, the signal from the filter is averaged over a predetermined number of samples. For example, an average may be calculated for every 200 samples. In step S18, a determination is made as to whether the user has enabled data saving in manual operation M1. If data saving has been enabled, the averaged data (e.g., average voltages) from step S16 is saved (e.g., to a file, such as a text file) in step S20. If data saving has not been enabled, the averaged data is not saved (not shown). In either situation, the processing proceeds (not shown) to step S22.

In step S22, the averaged data from step S16 is converted into pressure values (e.g., in mmHg). In step S24, a determination is made as to whether the user has enabled data saving. If data saving has been enabled, the pressure values are saved (e.g., to a text file) in step S26. If data saving has not been enabled, the pressure values are not saved (not shown). In either situation, the processing proceeds (not shown) to step S28.

In step S28, a determination is made as to whether the user is zeroing the gauge in manual operation M2. If the user is zeroing the gauge, the current pressure value from step S22 is saved in memory (such as memory 34 of computer system 14) as the zero threshold in step S30. If the user is not zeroing the gauge, new pressures are calculated in step S32. The new pressures equal the pressure values from step S22 minus the zero threshold saved in memory from step S30. In step S34, a determination is made as to whether the user has enabled data saving. If data saving has been enabled, the new pressure values are saved (e.g., to a text file) in step S36. If data saving has not been enabled, the new pressure values are not saved (not shown). In either situation, the processing proceeds (not shown) to step S38.

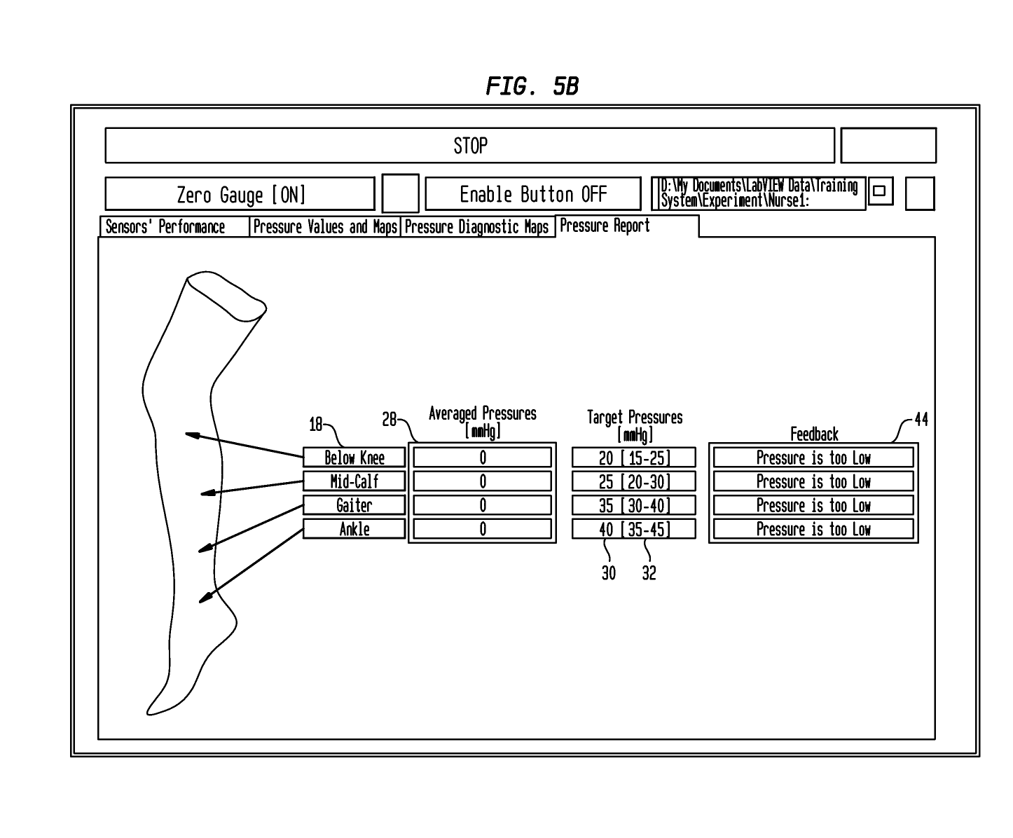

In step S38, the new pressures from step S32 are displayed by the output device 24 (see, e.g., the numerical pressure values 26 for each of the sensors in FIG. 5A). In step S40, the new pressure values are mapped onto a model of the limb 12. For example, the pressure values from different sensors 16 may be associated with respective locations of the sensors 16 on a 3D model of the limb 12. A graphical representation of this mapping is displayed by the output device 24 in step S42 (see, e.g., the color coded pressure map 40 in FIG. 5A). The new pressure values from step S32 are also compared to target pressure values (or ranges of values) in S44. For example, the difference between one of the new pressure values and a target pressure value for that particular sensor location may be calculated. That difference is then mapped onto a model of the limb 12 in step S46. That is, for example, the pressure differences with respect to each sensor 16 may be associated with respective locations of the sensors 16 on a 3D model of the limb 12. A graphical representation of this mapping is displayed by the output device 24 in step S48 (see, e.g., the color coded pressure map 42 in FIG. 5A).

In step S50, for each predefined region of the limb 12 (e.g., each level 18 of the limb), the new pressure values calculated in step S32 from all of the sensors within the region are averaged. In step S52, those average pressure values for each region are displayed by the output device 24 (see, e.g., the average pressure values 28 in FIGS. 5A-B). In step S54, a determination is made as to whether the user has enabled data saving. If data saving has been enabled, the average pressure values from step S50 are saved (e.g., to a text file) in step S56. If data saving has not been enabled, the average pressure values are not saved (not shown). In either situation, the processing proceeds (not shown) to step S58.

In step S58, the average pressure values from step S50 are compared to target pressure values for the corresponding regions. For example, the difference between one of the average pressure values and a target pressure value (or range of target pressure values) for that particular region may be calculated. Based on the comparison in step S58, feedback information (such as textual instructions) is displayed by the output device 24 in step S60. For example, if the average pressure value for a particular region (e.g., level 18) is lower than the target pressure range for that region (or is beyond an acceptable deviation from the target pressure value for that region), the output device 24 may display a textual message stating, for example, “pressure is too low” or “extremely low pressures” (see, e.g., the text signals 44 in FIGS. 5A-B). One example of an acceptable deviation from a target pressure value is a deviation of up to mmHg from the target pressure value. The feedback information displayed by the output device 24 in step S60 may provide qualitative information regarding the pressure differences calculated in step S58, as discussed further below.

One example of a display provided by the output device 24 is illustrated in FIG. 5A. The output device 24 may display numerical values for the interface pressures. For example, a numerical value 26 may be displayed for each of the sensors 16, and/or an average value 28 from multiple sensors 16 may be displayed. The multiple sensors 16 for which an average value 28 is displayed may be a group 38 of sensors 16 representing a region (e.g., a particular level 18) of the limb 12 (such as that shown in FIG. 2). The output device 24 may also display target pressure values 30 and/or ranges 32 of desirable pressures. The computer system 14 may also calculate and display numerical values representing the difference between the pressure actually applied and the target pressure values and/or ranges.

The target pressure values 30 and/or ranges 32 may be based on various factors, including the type of venous disease and the type of limb being treated. The computer system 14 may be configured to store data (e.g., in memory 34) relating to such factors, such that target pressure values 30 and/or ranges 32 can be retrieved and/or calculated based on the selected factors. The computer system 14 may be configured to receive such factors from the user (e.g., via an input device 36). The computer system 14 may also be configured to receive the target pressure values 30 and/or ranges 32 directly from the user. The training system 10 may also be able to determine certain factors (e.g., the type of limb and/or disease) by itself. In this regard, the artificial limbs 12 may be associated with certain data (e.g., type of limb and/or disease), and the computer system 14 may be configured to recognize which artificial limb 12 is connected to the system and retrieve the associated data. The artificial limb 12 may also communicate such data to the computer system 14 when the two components are connected.

For some applications, it may be desirable to apply different pressures at different locations along the patient's limb (e.g., a gradient extending along the length of the limb). For example, in the case of a leg, it may be desirable to apply a pressure of about 40 mmHg (˜5300 Pa) at the ankle, decreasing to about 20 mmHg (˜2700 Pa) below the knee. In such a case, the computer system 14 may be programmed to associate each of the sensor regions or levels 18 with a different target pressure value 30 and/or range 32.

The output device 24 may be configured to display non-numerical information (e.g., qualitative information) regarding the pressure values. Such non-numerical information may be provided in connection with each of the sensors 16 and/or in connection with a group (such as group 38) of sensors 16 representing a region (e.g., level 18) of the limb 12. In one example, the non-numerical information may include color-coded outputs representing variance of the applied pressure from the target pressure values and/or ranges. For example, the colors may be: white for pressures at least 20 mmHg (˜2700 Pa) higher than the target pressure value; red for pressures at least 10 mmHg (˜1300 Pa) higher than the target pressure value; green for no difference (or within an acceptable range (e.g., 5 mmHg)) from the target pressure value; light blue for pressures at least 10 mmHg lower than the target pressure value; and pink for pressures at least 20 mmHg lower than the target pressure value. In another example, non-numerical text signals or indications 44 (and/or audio signals) (e.g., “very low,” “slightly low,” “correct,” “slightly high,” and “very high”) may be provided for use by an operator. In yet another example, only three non-numerical signals (e.g., text and/or color) may be used: one for the correct pressure value, one for higher pressure values, and one for lower pressure values. Although examples having five and three non-numerical signals have been discussed, additional embodiments may provide more or fewer non-numerical signals to indicate different degrees of pressure deviations.

The output device 24 may provide a map that graphically illustrates the limb 12. Such a map may indicate (e.g., by color codes, as discussed above) the absolute pressure values and/or deviations from the target values in different regions of the limb 12, so that the user can visualize the consistency of application of the MCP (e.g., bandage). As shown in FIG. 5A, one color coded map 40 may illustrate the qualitative absolute pressure values across the limb 12, and another color coded map 42 may illustrate the qualitative deviations from the target pressures across the limb 12. The output device 24 may also include color codes 41, 43 next to the respective maps 40, 42 that indicate the colors associated with particular pressure values. It is to be appreciated that, although the maps 40, 42 and associated color codes 41, 43 are not illustrated in FIG. 5A in the aforementioned colors, those items could be provided with color-coded outputs as discussed above, or any other desired colors.

Beneficially, in the case where a pressure gradient is to be applied upon the limb 12, the non-numerical information communicated to the user may be consistent at different locations along the limb 12, even when the target pressure values 30 are not consistent at those locations. That is, if the target pressure value is 20 mmHg at one location and 40 mmHg at another location, the output device 24 may display information relative to the target pressure value 30 at each location. For example, if the target pressure value is 20 mmHg and the user is applying 10 mmHg, the output device 24 may indicate that the applied pressure is less than the target amount (and/or may provide qualitative and/or quantitative information indicating the degree to which the applied pressure is less than the target amount). In a location where the target pressure value 30 is, for example, 40 mmHg and the user is applying 30 mmHg, the output device may provide similar information. This consistent form of feedback may help make it easier for the user to apply the MCP properly, as the user may not need to keep track of different target pressure values at different locations along the limb, and the non-numerical information may be easier to interpret during use than numerical values.

Another example of a display provided by the output device 24 is illustrated in FIG. 5B. The exemplary display of FIG. 5B is similar to that of FIG. 5A except that the display of FIG. 5B does not include numerical values 26 for each of the sensors 16, and the display of FIG. 5B does not have color coded maps 40, 42.

In using the training system 10, a user may first input a variety of information (e.g., disease, type of limb, type of MCP, etc.). The user may then apply the MCP (e.g., a compression bandage) to the artificial limb 12, and the output device 24 may provide information to the user relating to the accuracy and consistency of application. The training system 10 may be configured to provide real-time feedback during the application of the MCP, which may allow the user to learn when and where mistakes are being made while the MCP is being applied, and may allow the user to make adjustments as necessary during application. The computer system 14 may be configured to transmit data regarding the training session to an electronic record system, and/or the computer system 14 may have a printing function, so that a hard copy report relating to the training session may be generated. The feedback provided by the computer system 14 may help the user learn and practice proper techniques for applying a MCP (such as an elongated compression bandage) with the correct pressure and extension for particular diseases.

The systems and apparatuses shown and described herein may be used in conjunction with any or all of the systems and apparatuses shown and described in the pending U.S. nonprovisional patent application filed on the same date and naming the same inventor as the present nonprovisional patent application, and entitled “Medical Compression Product, System Utilizing Such Product, And Program For Use Therewith,” the entire disclosure of which is fully incorporated by reference herein.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A system for training a nurse or practitioner to apply a medical compression product, the system comprising:
an artificial limb having a geometry representative of a limb of a patient, the limb comprising a plurality of sensors disposed thereon, each of the sensors being operable to measure a predetermined parameter indicative of a pressure being applied by the medical compression product to the artificial limb, the sensors being arranged to provide measurements with respect to a first location and a second location on the limb;
a processor arranged to receive data from the plurality of sensors corresponding to the measured predetermined parameter and to compare the data received to a plurality of numerical target pressure ranges which include a first target pressure range relating to the first location on the limb and a second pressure range relating to the second location on the limb, the second target pressure range having a different range of values than the first target pressure range; and
an output device connectable to the processor to:
(i) provide a non-numerical indication to an operator with respect to the first location when the pressure applied by the medical compression product to the artificial limb at the first location is within the first target pressure range, and
(ii) provide the same non-numerical indication with respect to the second location as with respect to the first location when the pressure applied by the medical compression product to the artificial limb at the second location is within the second target pressure range.

2. The system of claim 1, wherein the plurality of sensors are arranged in a plurality of groups, each group being associated with a different region of the artificial limb.

3. The system of claim 1, wherein the system includes a plurality of artificial limbs, each limb having a different geometry.

4. The system of claim 1, wherein the artificial limb has a geometry representative of a leg of a patient.

5. The system of claim 1, wherein the medical compression product is a compression bandage.

6. The system of claim 1, wherein the first target pressure range is within a first acceptable pressure difference from a first target pressure value, and wherein the second target pressure range is within a second acceptable pressure difference from a second target pressure value.

7. The system of claim 6, wherein each of the first and second acceptable pressure differences is 5 mmHg.

8. The system of claim 1, wherein the output device is a visual display.

9. The system of claim 1, wherein the non-numerical indication is a non-numerical text-based signal.

10. The system of claim 1, wherein the non-numerical indication is a color-coded signal.

11. The system of claim 10, wherein the color-coded signal is provided on a graphical representation of the artificial limb.

12. A device for use with a system for training a nurse or practitioner to apply a medical compression product, comprising:
an artificial limb having a geometry representative of a limb of a patient, the limb comprising a sensor disposed thereon, the sensor being operable to measure a predetermined parameter indicative of a pressure being applied by the medical compression product to the artificial limb.

13. The device of claim 12, in which the limb comprises a plurality of sensors, wherein the plurality of sensors are arranged in a plurality of groups, each group being associated with a different region of the artificial limb.

14. The device of claim 12, wherein the artificial limb has a geometry representative of a leg of a patient.

15. A non-transitory computer readable medium having stored thereon a program executable by a computer, said program comprising:
comparing data received from a plurality of sensors disposed on an artificial limb to a plurality of numerical target pressure ranges, the data corresponding to a predetermined parameter measured by the sensors, the predetermined parameter indicative of a pressure being applied by a medical compression product to a first location and a second location on the artificial limb, wherein the target pressure ranges include a first target pressure range relating to the first location on the limb and a second target pressure range relating to the second location on the limb, the second target pressure range having a different range of values than the first target pressure range;
providing to an output device a first signal representative of a first non-numerical indication with respect to the first location when the pressure applied by the medical compression product to the artificial limb at the first location is within the first target pressure range; and
providing to the output device a second signal representative of a second non-numerical indication with respect to the second location, the second non-numerical indication being the same as the first non-numerical indication when the pressure applied by the medical compression product to the artificial limb at the second location is within the second target pressure range.

16. The medium of claim 15, wherein the first target pressure range is within a first acceptable pressure difference from a first target pressure value, and wherein the second target pressure range is within a second acceptable pressure difference from a second target pressure value.

17. The medium of claim 16, wherein each of the first and second acceptable pressure differences is 5 mmHg.

18. The medium of claim 15, in which the output device includes a visual display, and wherein the first and second signals represent text, such that when the first and second signals are provided to the output device the representative text associated therewith is displayed thereat.

19. The medium of claim 15, in which the output device includes a visual display, and wherein the first and second signals represent color, such that when the first and second signals are provided to the output device, the representative color associated therewith is displayed thereat.

20. The medium of claim 19, wherein, when the first and second signals are provided to the output device, the representative color associated therewith is displayed on a graphical representation of the artificial limb.
